(19) United States
(12) Patent Application Publication
(10) Pub. No.: US 2019/0172066 A1
(43) Pub. Date: Jun. 6, 2019

(54) Systems and Methods for Performing Network-Based Transactions

(71) Applicant: MASTERCARD INTERNATIONAL INCORPORATED, Purchase, NY (US)

(72) Inventor: Neil Rose, Creve Coeur, MO (US)

(21) Appl. No.: 15/829,103

(22) Filed: Dec. 1, 2017

(51) Int. Cl. G06Q 20/40; G06Q 20/22

(52) U.S. Cl. CPC G06Q 20/4014; G06Q 50/01; G06Q 20/227

(57) ABSTRACT

Systems and methods are provided for facilitating network-based transactions between entities. One exemplary method includes identifying, by a platform computing device, a first entity associated with a profile in a data structure associated with the platform computing device and causing at least one profile associated with at least one recipient to be displayed to the first entity. The method also includes, in response to a selection by the first entity of the at least one recipient: retrieving, by the platform computing device, credentials for an account associated with the at least one recipient; initiating a network-based transaction to the account associated with the at least one recipient; and altering, by the platform computing device, a metric associated with the profile of the first entity consistent with the network-based transaction and modifying a hierarchy of the first entity relative to other entities based on the altered metric.

### FIELD

The present disclosure generally relates to systems and methods for use in facilitating network-based transactions between entities.

### BACKGROUND

This section provides background information related to the present disclosure which is not necessarily prior art.

People are known to provide donations to people that are less fortunate and/or in need. In general, donations may be provided through payments to charitable organizations, which, in turn, distribute, the donations (or goods and/or services purchased with the donations) to those associated with a stated purpose of the charitable organizations. For example, emergency-need charitable organizations (e.g., the American Red Cross™ organization, etc.) are known to accept donations and then use the donations to provide basic necessities in and/or around disaster areas. In another example, donation recipients are also known to solicit donations through websites (e.g., through the GoFundMe™ website, etc.), whereby the would-be donation recipients are able to tell their story and solicit funds from people associated with the websites (e.g., that have access to the websites, etc.). Other types of donation recipients and/or charitable organizations are known to solicit, accept, and/or deliver donations, in various forms and in various ways, to those in need, again, generally in accordance with stated purposes of the recipients and/or corresponding charitable organizations.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating donation transactions between donors and donation recipients;

FIG. 2 is a block diagram of a computing device that may be used in the exemplary system of FIG. 1;

FIGS. 3-12 are exemplary interfaces that may be displayed to a user in connection with the system of FIG. 1 for facilitating donation transactions between donors and donation recipients; and

FIG. 13 is an exemplary method, which may be implemented in connection with the system of FIG. 1 and in which the exemplar interfaces of FIGS. 3-12 may be used, for facilitating a donation transaction by a donor to a donation recipient.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Donations may be provided to donation recipients, directly and/or indirectly, through charitable organizations. Often, the donations are directed to a particular purpose, which may include a cause or a discrete event (e.g., a natural disaster, etc.). Uniquely, the systems and methods herein permit donation recipients and/or charitable organizations to post recipient profiles and to solicit donations, and permit donors to allocate and/or donate monies to the donation recipients, as desired, based on the profiles, etc. The systems and methods herein may also permit donors to donate to particular events (e.g., natural disasters, etc.) without choosing specific recipients, whereby the donations may then be randomly distributed amongst all active recipient profiles. Consistent with the description herein, a donation platform is provided, which is accessible to donation recipients and donors. The donation recipients (and/or associated organizations) are able to provide profiles, which are then viewable by donors. The donors, in turn, may donate monies to the donation recipients (or more broadly to a particular event with which various donation recipients are associated), through the platform, based on the profiles and, in doing so, build their own donor profiles. The donor profiles include not only donations by the donors, but also links to other donors and metrics relating to the breadth of the donations provided by the donors and/or their linked donors (e.g., thereby identifying and/or indicating Circles of Influence for the donors, etc.). The donations may then be distributed directly to payment accounts (e.g., prepaid accounts, etc.) associated with the donation recipients, as prepaid cards or via mobile payment applications, or they may be allotted as merchant credit at particular merchants or as credits with various social programs (e.g., food stamps, etc.), etc. In this manner, the donations are provided directly to donation recipients, whereby charitable organizations may be bypassed, to an extent, and donors may better understand where their donations are directed. Accordingly, the systems and methods herein provide gamification features to the donation process, such that the donors can directly identify donation recipients, track donations to such recipients, identify particular needs for the recipients (based on their profiles), compete with and/or challenge other donors, and participate in donations with other donors.

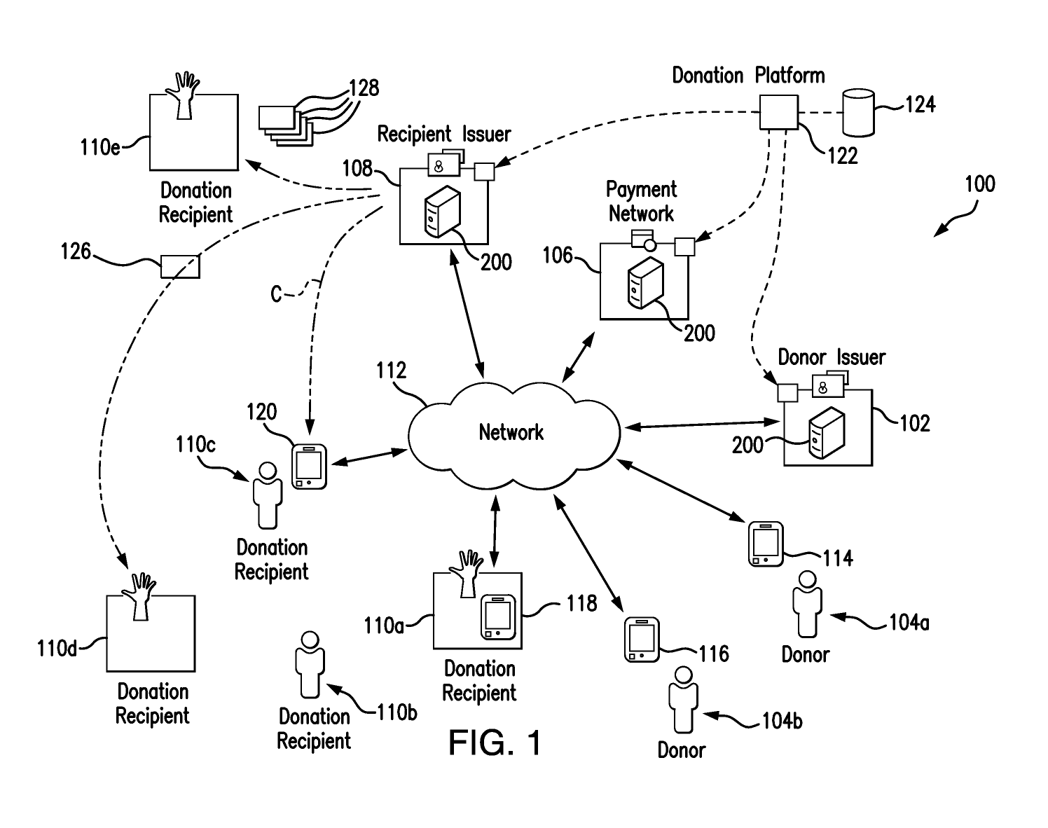

FIG. 1 illustrates an exemplary system 100 in which one or more aspects of the present disclosure may be implemented. Although the system 100 is presented in one arrangement, other embodiments may include the parts of the system 100 (or other parts) arranged otherwise depending on, for example, distribution of donation information (including funds) to donors and/or recipients, processing of payment account transactions, etc.

The system 100 generally includes a donor issuer 102, which issues an account to each of multiple donors 104a-b, a payment network 106, and a recipient issuer 108, which issues payment accounts associated with each of multiple donation recipients 110a-e, each of which is coupled to, and is in communication with (and/or includes access to), network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts or users illustrated in FIG. 1, or any combination thereof. For example, network 112 may include multiple different networks, such as a private payment transaction network made accessible by the payment network 106 to the issuers 102, 108 to facilitate network-based transactions therebetween and, separately, a public network (e.g., the Internet, etc.) through which the donors 104a-b may facilitate donations (broadly, a network-based transaction) to the donation recipients 110a-e, as described herein.

As described, each of the donors 104a-b in the system 100 is associated with an account issued by the donor issuer 102 (e.g., a checking account, a prepaid account, a credit account, a debit account, etc.). Among other things, the accounts can be used by the donors 104a-b to fund donations to one or more of the donation recipients 110a-e. The donation recipients 110a-e may include, for example, individuals, groups of individuals, charitable organizations or entities, relief funds or events, etc. In addition in the illustrated system 100, the donors 104a-b are associated with communication devices 114, 116 (e.g., smartphones, tablets, etc.), each coupled to (and in communication with) the network 112 to operate as described herein. Similarly, the donation recipients 110a, 110c are associated with communication devices 118, 120, each coupled to (and in communication with) the network 112 to operate as described herein. While the donation recipients 110b, 110d, 110e are not illustrated as associated with communication devices in the system 100, it should be appreciated that one or more of such donation recipients 110b, 110d may include a communication device in other embodiments.

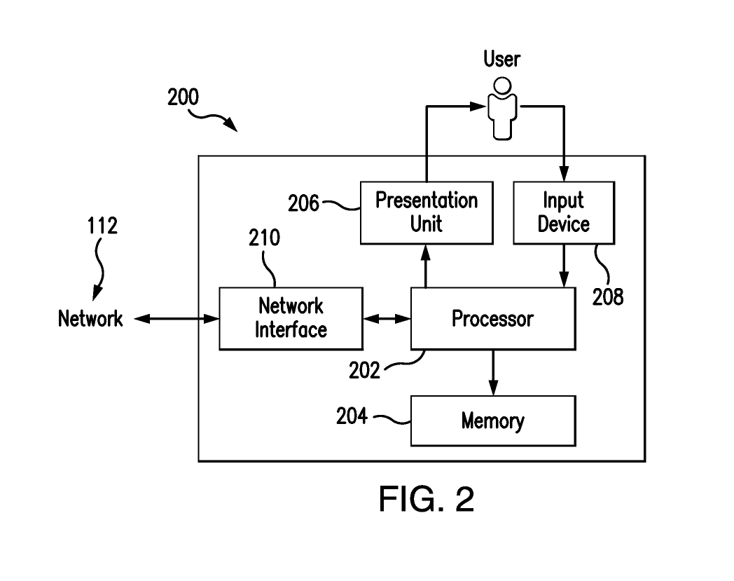

FIG. 2 illustrates exemplary computing device 200 used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are configured to function as described herein. In the system 100, the donor issuer 102, the payment network 106, and the recipient issuer 108 are each illustrated as incorporating a computing device 200, coupled to the network 112. In addition, each of the communication devices 114-120 may be considered a computing device generally consistent with computing device 200. That said, the system 100 should not be considered to be limited to the computing device 200, as described below, as different computing devices and/or arrangements of computing devices may be used. In addition, different components and/or arrangements of components may be used in other computing devices in other embodiments.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the operations described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, donor profiles, donation recipient profiles, transaction data, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

In the exemplary embodiment, the computing device 200 also includes a presentation unit 206 that is coupled to (and that is in communication with) the processor 202 (however, it should be appreciated that the computing device 200 could include output devices other than the presentation unit 206, etc.). The presentation unit 206 outputs information (e.g., charity information, donor preferences, donation summaries, donation recipient information, other donation data, etc.), visually, for example, to a user of the computing device 200 such as, for example, one or more of donors 104a-b, one or more of donation recipients 110a, 110c, users associated with the donation issuer 102, users associated with the recipient issuer 108, etc. Various interfaces (e.g., as defined by network-based applications and/or conventional applications, etc.) may be displayed at computing device 200, and in particular at presentation unit 206, to display and/or solicit certain information, as described herein, for example, and displayed at the presentation unit 206. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user (i.e., user inputs) such as, for example, login information from one or more of the donors 104a-b to access a donation platform herein to facilitate donations, donation amounts, donation preferences, etc. The input device 208 is coupled to (and is in communication with) the processor 202 and may include, for example, one or more of a keyboard, a pointing device, a mouse, a stylus, a card reader, a camera, a touch sensitive panel (e.g., a touch pad or a touch screen, etc.), and/or other suitable input device. Further, in various exemplary embodiments, a touch screen may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., a Wi-Fi adapter, a Bluetooth® adapter, etc.), a mobile network adapter, or other device capable of communicating to one or more different networks, including the network 112. In some exemplary embodiments, the computing device 200 may include the processor 202 and one or more network interfaces (including the network interface 210) incorporated into or with the processor 202.

Referring again to FIG. 1, the system 100 includes a donation platform 122, which is specifically configured to perform one or more of the operations described herein. In connection therewith, the donation platform 122 may be considered a computing device (and/or considered implemented in a computing device) consistent with computing device 200, and specifically configured as described herein. In general, the donation platform 122 is independent of/from the payment network 106 and/or the issuers 102, 108. That said, the donation platform 122 may be integrated into the payment network 106 and/or the issuers 102, 108, in whole, or in part, in other embodiments, as indicated by the dotted lines in FIG. 1. In at least one embodiment, the donation platform 122 may also (or alternatively) be included in the donation recipient 110a (or one or more of the donation recipients 110d, 110e), where the donation recipient 110a (and the donation recipients 110d, 110e) is (are) a charitable or other type of organization, or group, or event, etc.

In one aspect of the present disclosure, the donation platform 122 is configured to register the donors 104a-b and each of donation recipients 110a-e thereto.

For example, when the donors 104a-b desire to provide a donation as described herein, they interact with the donation platform 122 to facilitate such registration. In so doing, the donors 104a-b may initially access a website provided by and/or associated with the donation platform 122 (or, potentially, a network-based application supported by one of the illustrated parts of the system 100 (e.g., the payment network 106, etc.) or other parts not shown herein; etc.), via the corresponding communication devices 114, 116 or other accessible computing device 200. The donors 104a-b then interact with the donation platform 122, again via their respective communication devices 114, 116 (or other computing device 200) and network 112. As part of the interaction, the donation platform 122 is configured to solicit profile information from the donors 104a-b, such as, for example, name, address, contact information, account credentials for the account(s) issued by the issuer 102 and from which donations are to be funded, etc. In addition, the donation platform 122 may solicit donation preferences from the donors 104a-b for the profiles (e.g., particular regions for aid; particular aid categories such as food, medicine, etc.; particular types of aid such as flood relief, etc.; etc.), In response to receipt of the information, the donation platform 122, generally, is configured to register the donors 104a-b, whereby profiles for the donors 104a-b are created and stored in a data structure 124 included in and/or associated with the donation platform 122. Often, in various embodiments, in connection with the registration, the donation platform 122 is configured to generate donation accounts and provide access credentials to the donors 104a-b (e.g., login credentials, passwords, PINs, etc.) thereto, whereby the donors 104a-b are able to subsequently access their accounts/profiles at the donation platform 122 and instruct the donation platform 122 to operate as described herein (e.g., provide donations to one or more of the donation recipients 110a-e, view donation histories, etc.).

Likewise, when the donation recipients 110a-e (be it a charitable/relief organization, a partner organization, an individual, etc.) desire to receive donations as described herein, the donation recipients 110a-e interact with the donation platform 122 to facilitate registration with the donation platform 122. In so doing, the donation recipients 110a-e may initially access the website provided by and/or associated with the donation platform 122, via their corresponding communication devices (e.g., communication devices 118, 120; etc.) or other available/accessible computing device 200. The donation recipients 110a-e then interact with the donation platform 122, again via their respective communication devices (or other available computing device 200) and network 112. As part of the interaction, the donation platform 122 is configured to solicit information related to the donation recipients 110a-e, such as, for example, name, address, contact information, descriptions or narratives of the needs associated with the donation recipients 110a-e, etc. In response to receipt of the information, the donation platform 122, generally, is configured to register the donation recipients 110a-e, whereby profiles for the donation recipients 110a-e are generated and stored in the data structure 124 included in and/or associated with the donation platform 122.

In addition, in connection with registering the donation recipients 110a-e, the donation platform 122 is configured to associate a payment account (or multiple payment accounts) with each of the registered donation recipients 110a-e (to receive donation funds herein). The payment accounts may include credit accounts, prepaid accounts, savings accounts, etc. Specifically, for example, for each of the donation recipients 110a-e, the donation platform 122 is configured to select a payment account (or multiple payment accounts), from a series of un-associated payment accounts issued by the recipient issuer 108, and to associate each of the payment account(s) with a particular one of the donation recipients 110a-e. The payment account(s) and, more specifically, credentials associated with the payment account(s), is/are then appended to and/or included in the profile for the particular one of the donation recipients 110a-e. Each of the donation recipients 110a-e is then associated with a payment account in this manner for receiving donation funds, as described herein. With that said, it is contemplated that in some cases (e.g., in connection with donation recipients in very rural areas, etc.) receipt of the payment accounts by some donation recipients may be a first form of identification for the recipients.

What's more, in some implementations of the present disclosure, one or more of the donation recipients 110a-e (e.g., donation recipient 110a, donation recipient 110d, etc.) may include a partner organization (e.g., the World Food Program, etc.) that may be configured to register its services through the donation platform 122, thereby providing a storefront for other aid recipients to use their donation benefits through prepaid cards or directly as a store credit, etc. In so doing, the partner organization may be able to offer volume discounts for its services as it may already be in a given disaster area providing relief.

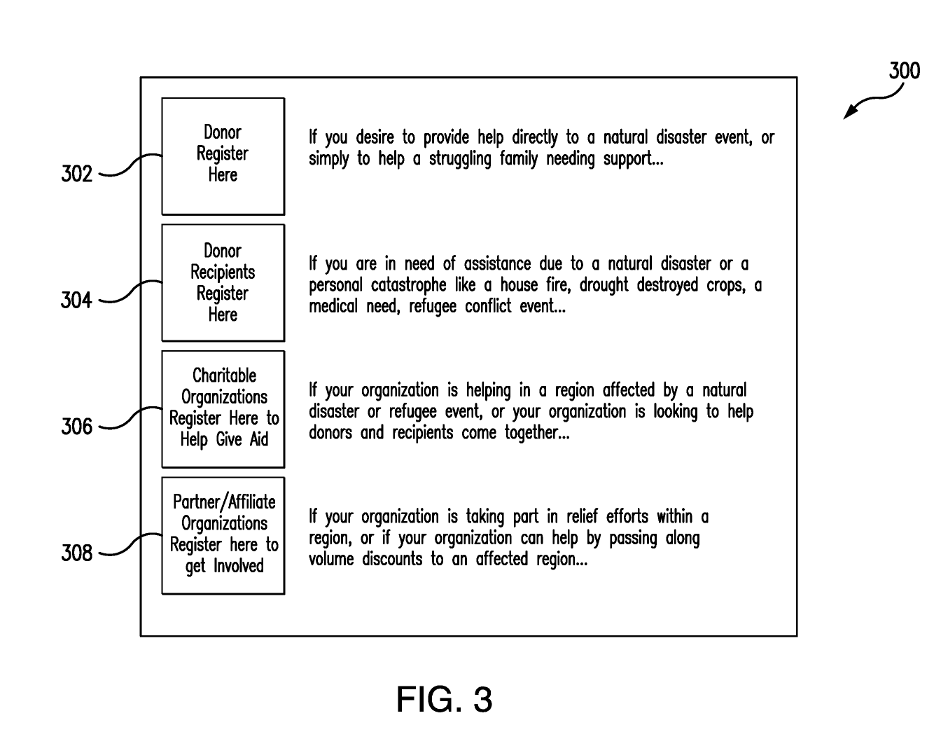

With that said, FIG. 3 illustrates an exemplary registration interface 300 that may be displayed to the donors 104a-b and donation recipients 110a-e, upon accessing the website associated with the donation platform 122, to facilitate registration. As shown, the registration interface 300 includes multiple options 302-308 for registering donors (e.g., donors 104a-b, etc.), individual donation recipients (e.g., donation recipients 110b-c, etc.), charitable organizations (e.g., donation recipients 110a, 110d, etc.), and partner/affiliate organizations (e.g., donation recipient 110e, etc.). As such, to ultimately register with the donation platform 122, the donors 104a-b and donation recipients 110a-e select the appropriate one of the options 302-308 and proceed to register with the donation platform 122 as described herein.

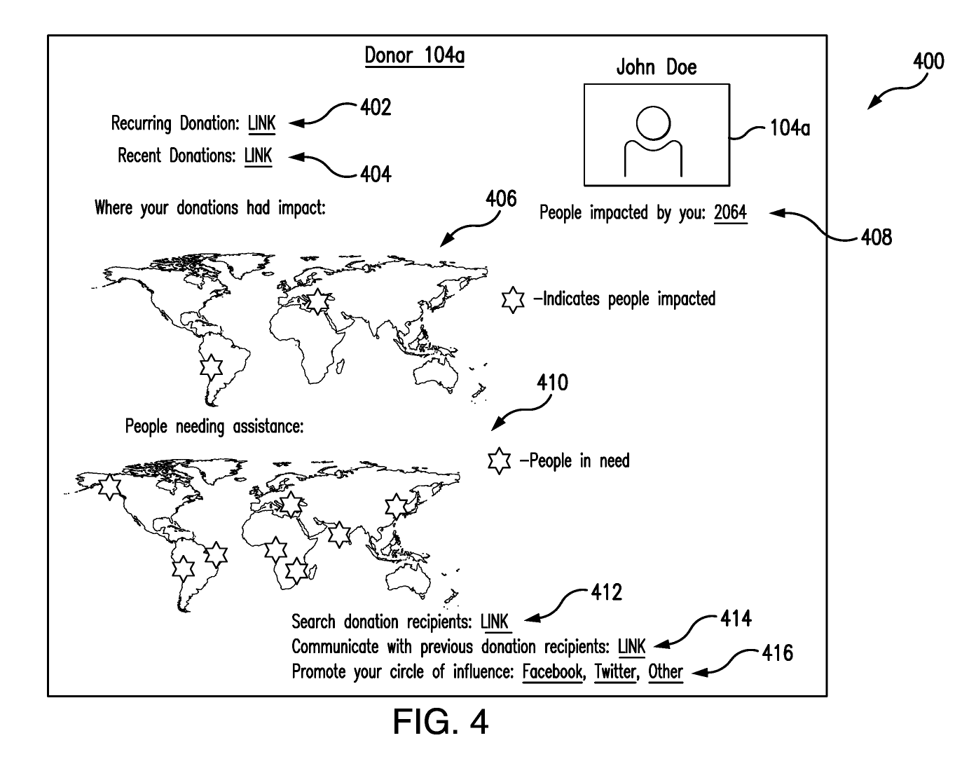

In addition, FIGS. 4-7 then illustrate multiple interfaces 400-700 that may be displayed to the donors 104a-b and donation recipients 110a-e, once registered, upon accessing the donation platform 122. For example, FIG. 4 illustrates an exemplary donor profile interface 400, which may be displayed to the donor 104a at his/her communication device 114, by the donation platform 122, once the donor 104a is registered and upon the donor 104a accessing the donation platform 122. In connection therewith, the donation platform 122 generally displays a network environment to the donor 104a via the interface 400. The illustrated interface 400 generally includes links 402, 404 for the donor 104a to access his/her pending donations and donation history, respectively, and a map 406 illustrating where donations by the donor 104a have caused an impact. In connection therewith, the interface 400 also includes an indication 408 of a number of people impacted by donations from the donor 104a (i.e., 2064 people). The interface 400 further includes a map 410 of donation recipients 110a-e needing assistance, and a link 412 for the donor 104a to facilitate a search to identify particular ones of the donation recipients needing assistance. Moreover, the interface 400 includes a link 414 for the donor 104a to communicate with prior donation recipients, and links 416 for the donor 104a to connect with other donors as part of his/her Circle of Influence (as described herein).

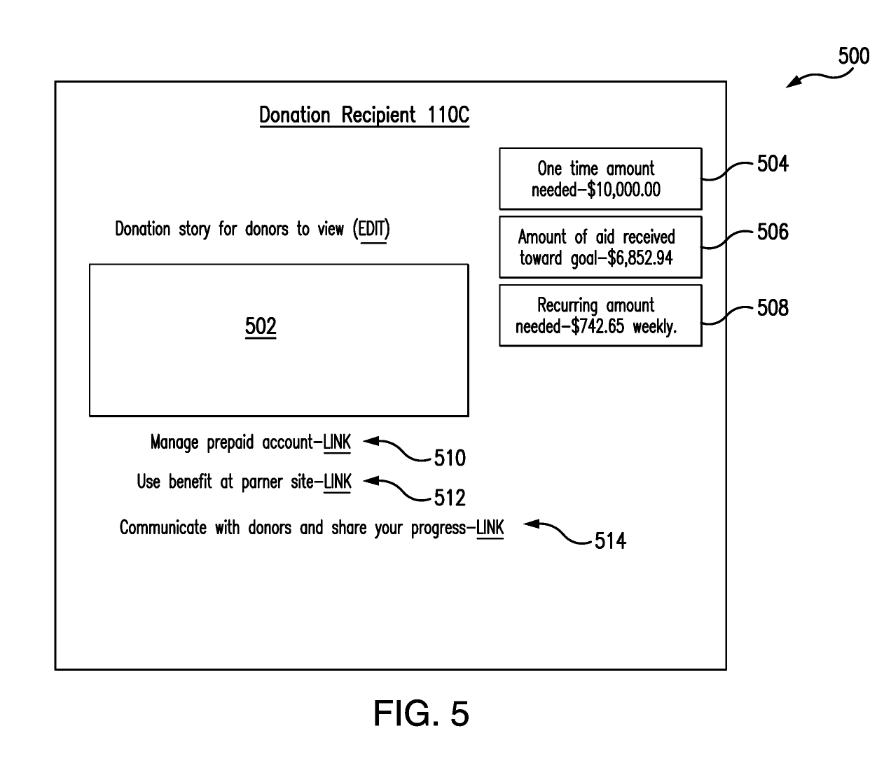

FIG. 5 illustrates an exemplary donation recipient profile interface 500, which may be displayed to the donation recipient 110c, for example, as an individual donation recipient, (at a computing device associated therewith (e.g., at communication device 120, etc.)), once the donation recipient 110c is registered and upon the donation recipient 110c accessing the donation platform 122. As shown, the interface 500 includes fields 502-508 to allow the donation recipient 110c to provide a reason or need (or testimonial) for the given donation, and to provide various amounts associated with the need (e.g., a one-time amount of $10,000 is needed, and the donation recipient 110c has received $6,852.94 toward the one-time amount, etc.). The interface 500 also includes links 510-514 to allow the donation recipient 110c to manage his/her prepaid account to which donations will be applied, to allow the donation recipient 110c to use benefits at a partner site, and to allow the donation recipient 110c to communicate with donors to share/update progress, etc.

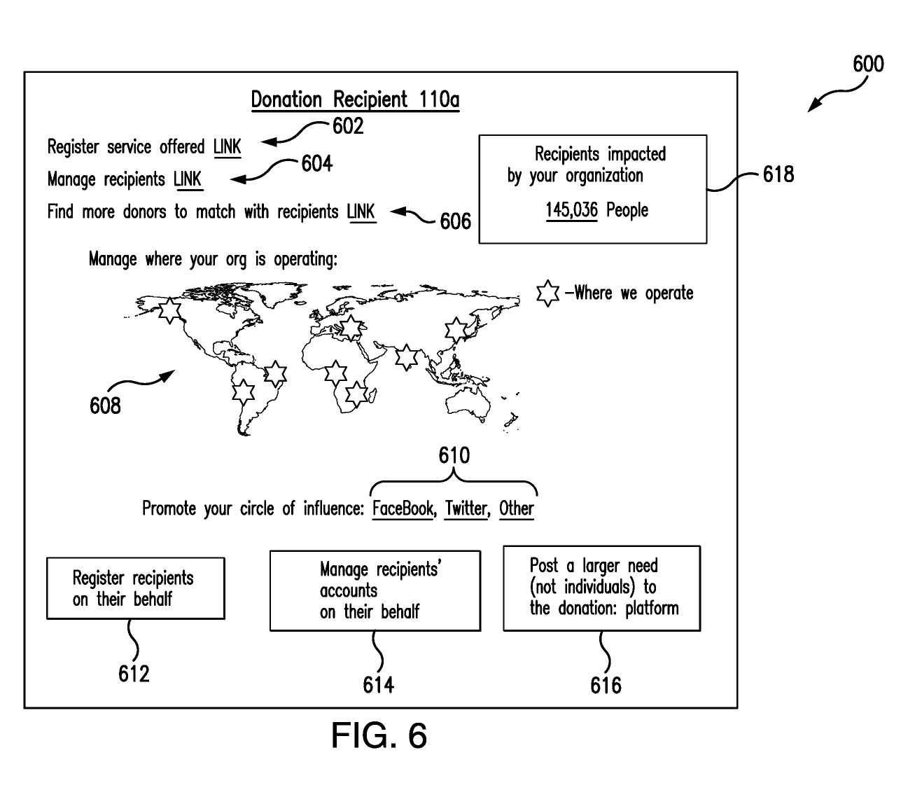

FIG. 6 illustrates another exemplary donation recipient profile interface 600, which may be displayed to the donation recipient 110a, for example, as a charitable organization, (at a computing device associated therewith (e.g., a communication device 118, etc.)), once the donation recipient 110a is registered and upon the donation recipient 110a accessing the donation platform 122. As shown, the interface 600 includes links 602-606 to allow the donation recipient 110a to register their services with the donation platform 122, to manage recipients of donations therethrough, and to search for donors to match with their recipients. The interface 600 also includes a map 608 illustrating where the donation recipient 110a is operating (and providing donations), and additional links 610 to connect with other donation recipients and/or donors as part of the donation recipient's Circle of Influence (as described herein). Further, the interface 600 includes options 612-616 to register recipients on their behalf, to manage recipient accounts on their behalf, and to post needs to the donation platform 122. In connection therewith, the interface 600 also includes an indication 618 of a number of people impacted by donations facilitated through the donation recipient 110a (i.e., 145,036 people).

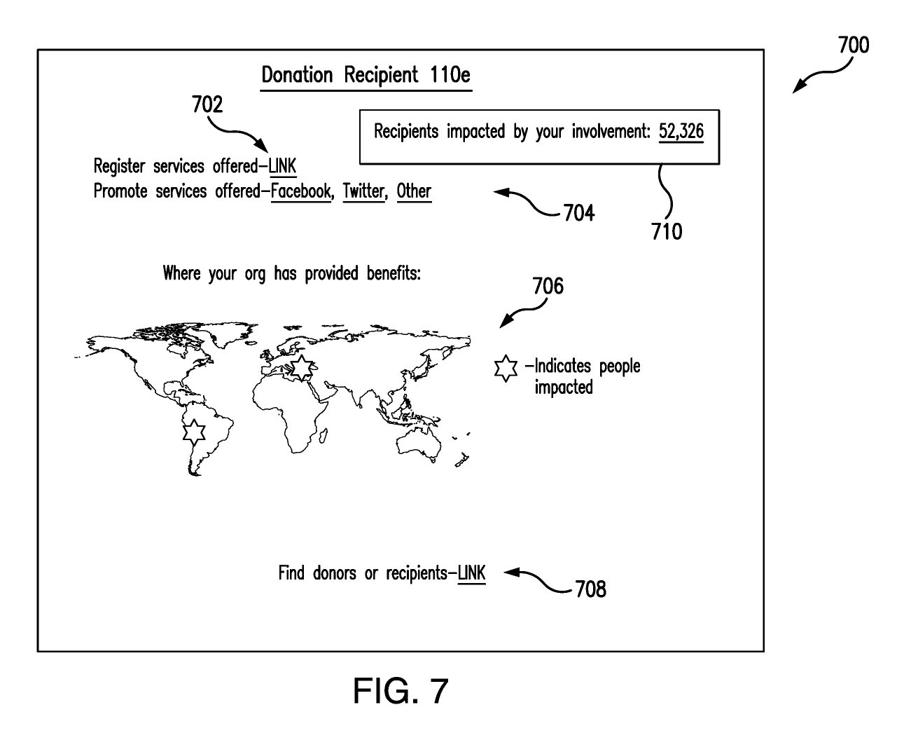

And, FIG. 7 illustrates still another exemplary donation recipient profile interface 700, which may be displayed to the donation recipient 110e, for example, as a partner/affiliate organization, (at a computing device associated therewith), once the donation recipient 110e is registered and upon the donation recipient 110e accessing the donation platform 122. As shown, the interface 700 includes links 702-704 to allow the donation recipient 110e to register their services with the donation platform 122 and to promote their services via social media. The interface 700 also includes a map 706 illustrating where the donation recipient 110e is operating (and providing donations), and an additional link 708 that allows the donation recipient 110e to search for donors and recipients for matching. In connection therewith, the interface 700 also includes an indication 710 of a number of people impacted by the activities provided through the donation recipient 110e (i.e., 52,326 people).

It should be appreciated that the interfaces 300-700 described above and illustrated in FIGS. 3-7 are exemplary in nature and do not limit the scope of the present disclosure. As such, it should also be appreciated that various other interfaces, with similar or different content, may be used in other embodiments.

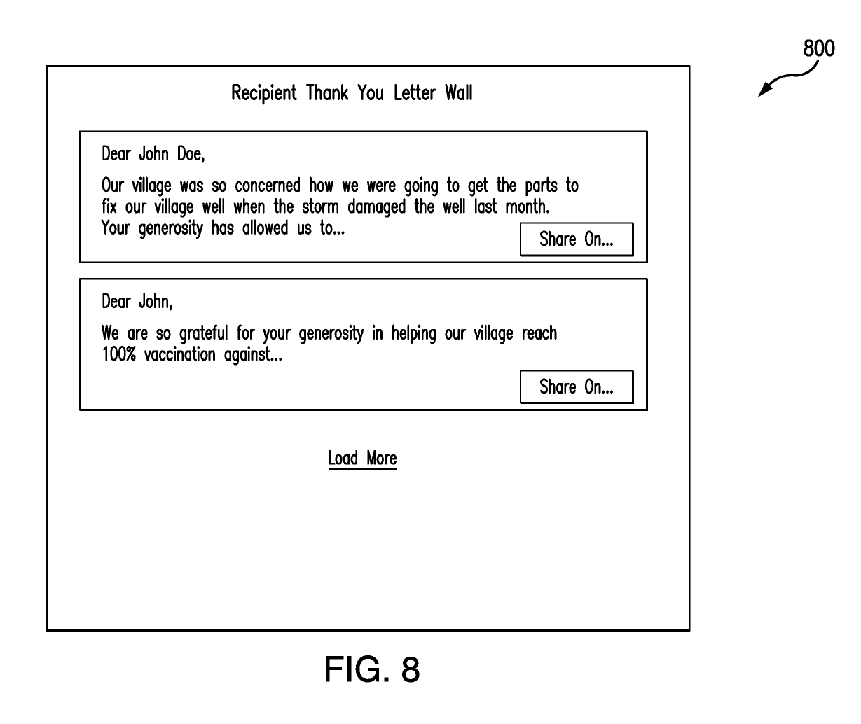

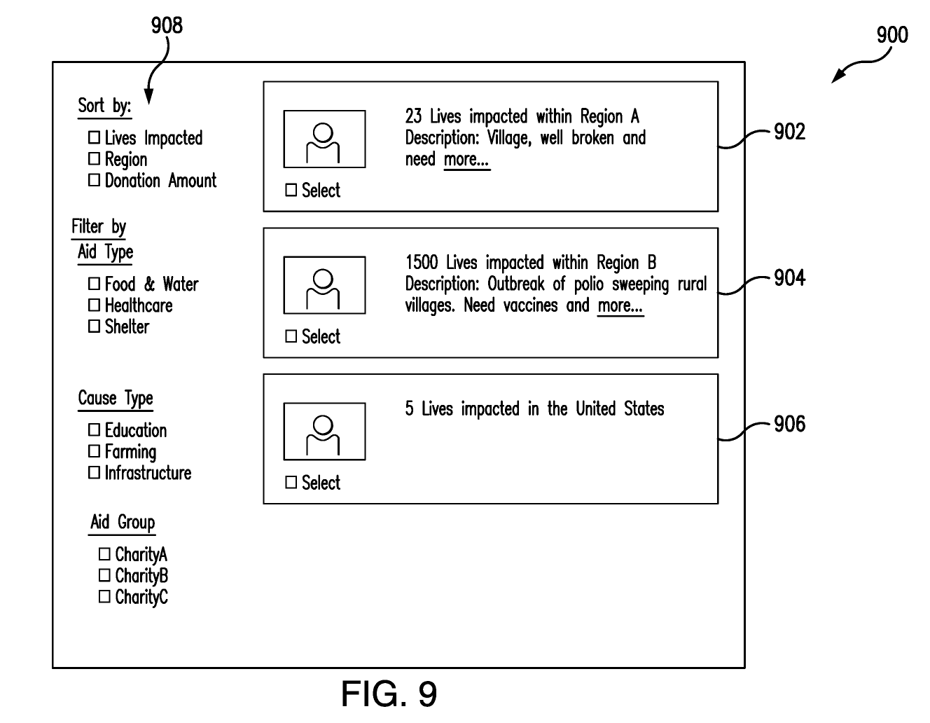

With reference again to FIG. 1, in another aspect of the present disclosure, the donation platform 122 is configured to provide a network environment to the donors 104a-b (e.g., via the website and upon the donors 104a-b accessing their donation accounts as generally shown in the exemplary interfaces 300-700 of FIGS. 3-7, etc.), in which the donors 104a-b are able to view the donation recipient profiles associated with the donation recipients 110a-e and potentially communicate with the donation recipients 110a-e (e.g., via a message board at the donation platform 122 such as included in message interface 800 in FIG. 8, etc.). In connection therewith, for example, the donors 104a-b are able to view the descriptions or narratives of the needs associated with the donation recipients 110a-e (as included in the donation recipient profiles) and/or potential disasters they are supporting, which in turn may entice and/or motivate the donors 104a-b to give/donate to one or more of the different donation recipients 110a-e. FIG. 9, for example, illustrates an exemplary interface 900 that may be displayed to the donor 104a to show potential donation recipients 902-906 (e.g., upon selection of link 412 to search for donation recipients in the donor profile interface 400, etc.). As part of identifying the potential donation recipients 902-906, the interface 900 also includes options 908 for sorting and filtering the listing of potential donation recipients, whereby the donor 104a is able to tailor his/her donation criteria. Then, when desired, the donor 104a may select one or more of the potential donation recipients 902-906 at the interface 900 and initiate a donation transaction (or multiple donation transactions) as described hereinafter. It should again be appreciated that the interfaces 800, 900 described above and illustrated in FIGS. 8 and 9 are exemplary in nature and do not limit the scope of the present disclosure, as various other interfaces, with similar or different content, may be used in other embodiments.

Additionally, via the network environment, the donation platform 122 is configured to receive donation requests from the donors 104a-b for one or more selected donation recipients 110a-e. The requests generally include indications of the particular ones of the donation recipients 110a-e to which donations are to be directed, amounts of such donations, one-time indicators or recurring indicators for such donations, payment accounts to be used to perform/fund such donations (e.g., when multiple payment accounts are registered/available through donors' profiles, etc.), etc. With that said, in connection with a recurring donation, the donation platform 122 may be configured to solicit, in addition to a donation amount, an interval for the recurring donation, a start date, and an end date (if any), etc. It should be appreciated that the donation transaction, for a recurring donation, will be substantially consistent with the description below, yet initiated automatically as specified by the donation recipients 110a-b, for example.

For example, in connection with a donation request by the donor 104a to the donation recipient 110d, the donor 104a (via his/her donation account) may initially transmit a donation request to the donation platform 122. In so doing, the donation request may indicate that a one-time $20.00 donation is to be made to the donation recipient 110d from his/her payment account issued by the donor issuer 102. In response, the donation platform 122 is configured to submit a corresponding authorization request to the donor issuer 102, for example, via the payment network 106 (and network 112). The authorization request may include, for example, an amount of the donation (i.e., $20.00), payment account credentials for the donor's identified payment account, and payment account credentials for the payment account associated with the donation recipient 110d (as appended to the donation profile for the donation recipient 110d, etc.), etc. The donor issuer 102 is configured to determine whether the donor's payment account is in good standing and whether there is sufficient credit or funds to complete the donation transaction. If approved, the donor issuer 102 is configured to provide an authorization reply back to the donation platform 122 (again, for example, via the payment network 106), which in turn is provided to the recipient issuer 108, whereby the donation transaction is posted to the payment account associated with the donation recipient 110d. The transaction is later cleared and/or settled by and between the donor issuer 102 and the recipient issuer 108, and also the payment network 106 (via appropriate agreements). Alternatively, if the donor issuer 102 declines the transaction, the donor issuer 102 is configured to transmit an authorization reply indicating the decline back to the donation platform 122, thereby permitting the donation platform 122 to indicate the decline to the donor 104a.

In the above example, when the donation transaction is posted to the payment account associated with the donation recipient 110d, the recipient issuer 108 is configured to transmit a payment card 126 (e.g., a prepaid payment card, etc.) to the donation recipient 110d associated with the payment account to which the donation funds were posted (since the donation recipient 110d does not include a communication device in this example). The donation recipient 110d may then use the payment card 126 in various different purchase transactions, as desired. This may similarly apply to donation recipient 110b.

In other example donation transactions, for example, involving the donation recipients 110a, 110c, when donation transactions are posted to the payment accounts associated with the donation recipients 110a, 110c, the recipient issuer 108 is configured to transmit electronic notifications to the donation recipients 110a, 110c at their communication devices 118, 120 indicating that the funds are available for use, for example, via an electronic wallet application, etc. (e.g., as indicated by arrow C in FIG. 1 in relation to donation recipient 110c, etc.) (e.g., in addition to transmitting a payment card, in lieu of transmitting a payment card, etc.).

In still other example donation transactions, for example, involving the donation recipient 110e, when donation transactions are posted to the payment accounts associated with the donation recipient 110e, the recipient issuer 108 may be configured to transmit multiple payment cards 128 (e.g., prepaid payment cards, etc.) to the donation recipient 110e for distribution to particular individuals in need. The particular individuals may then use the payment cards 128 in various different purchase transactions, as desired. For instance, the donation recipient 110e may include the American Red Cross™ organization, whereby in response to a particular event, the American Red Cross™ organization facilitates a relief effort for the event. In so doing, the American Red Cross™ organization may look to the donation platform 122 for donation funds and, upon receipt of the payment cards 128 comprising the donation funds, may distribute the payment cards 128 to individuals affected by the particular event (e.g., at an onsite emergency tent located at the particular event, etc.).

Further in the system 100, the donation platform 122 is also configured to provide different views and/or information at the network environment for the donors 104a-b, whereby the donors 104a-b are able to view images of relief efforts provided by ones of the donation recipients 110a-e, images of how donated funds are being used by the donation recipients 110a-e, other donors linked to the donors 104a-b (e.g., based in invitation requests by the donors 104a-b, etc.), Circles of Influence associated with the donations made by the donors 104a-b (e.g., listings of the donation recipients 110a-d to which donations have been made by the donors 104a-b, etc.), links to social media where donation information can be upload for sharing so that others associated with the donors 104a-b can view (or be given access to view) donations by the donors and/or their Circles of Influence, etc. (see, for example, the interfaces 400-700 of FIGS. 4-7, etc.)

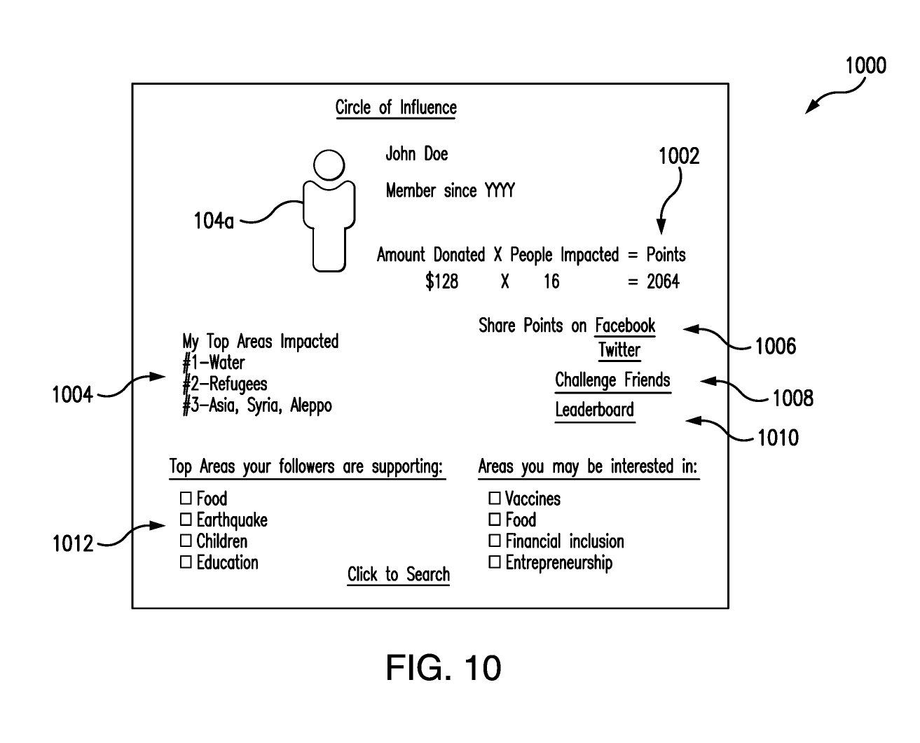

In connection therewith, the donation platform 122 may be configured to provide invitations and/or notifications to other donors 104a-b regarding potential donations. Specifically, for example, the donor 104a may wish to invite the donor 104b to donate to a specific donation recipient or to multiple donation recipients (e.g., in response to making a current donation, etc.), or generally, to participate in the donation platform 122 (when the donor 104b is not yet registered). To do so, the donor 104a provides contact information for the donor 104b, and specifies the donation recipient(s) and/or indicates a metric to be provided to the donor 104b. The donation platform 122, in turn, provides the invitation and/or notification to the donor 104b, in accordance with the provided contact information. In some embodiments the notification may include an indication of how much the donor 104a has donated to a particular recipient or in general, for a particular time frame or since registering with the donation platform 122. For example, FIG. 10 illustrates an exemplary challenge interface 1000 that may be displayed to the donor 104a to show potential donation recipients 902-906 (e.g., upon selection of link 412 to search for donation recipients in the donor profile interface 400, etc.).

Moreover, through the donation platform 122, the donor 104a may attempt to challenge, compete with, link with, etc. the donor 104b and/or other donors (e.g., as bragging, as an invitation to follow the donor 104a, etc.), whereby donation information related to one of the donors 104a-b would be available to the other one of the donors 104a-b. For example, the donor 104a may select an invitation to the donor 104b, to join a donor group in which the donor 104a is involved, or, potentially, to form a donor group with donor 104a. The donation platform 122, in turn, is configured to compile and transmit the invitation to the donor 104b, in accordance with the instruction provided by the donor 104a and/or in accordance with a profile associated with the donor 104b (if registered, for example).

With that said, FIGS. 10-12 illustrate various exemplary interfaces 1000-1200 through which the donor 104a may interact with his/her Circle of Influence and effect a gamification aspect of the donation platform 122 (e.g., to challenge other donors to donate more in general, or for a specified period, or to a specific cause, etc.; etc.). For example, FIG. 10 illustrates an exemplary Circle of Influence interface 1000 that may be displayed to the donor 104a to show an overview of his/her donations (e.g., upon selection of one of the links 416 in the interface 400 of FIG. 4 by the donor 104a to promote his/her Circle of Influence, etc.). In connection therewith, the interface 1000 includes an indication 1002 of points earned by the donor 104a through his/her donations (e.g., as a product of donation amount and people impacted, etc.) and a listing 1004 of top areas impacted by the donor's donations. The interface 1000 also includes an option 1006 for the donor 104a to share his/her points on social media, an option 1008 for the donor to challenge friends to make donations, and an option 1010 for the donor 104a to view a leaderboard (broadly, a hierarchy) of top donors (e.g., the donor 104a may implement an August back to school challenge based on who can generate the most influence points for the month of August to global school related causes, etc.). Further, the interface 1000 includes a search feature 1012, whereby the donor 104a may search for additional information and/or potential donation recipients based on different areas of need his/her followers are supporting and different areas of need in which he/she may be interested (e.g., potentially resulting in the interface 900 of FIG. 9, etc.).

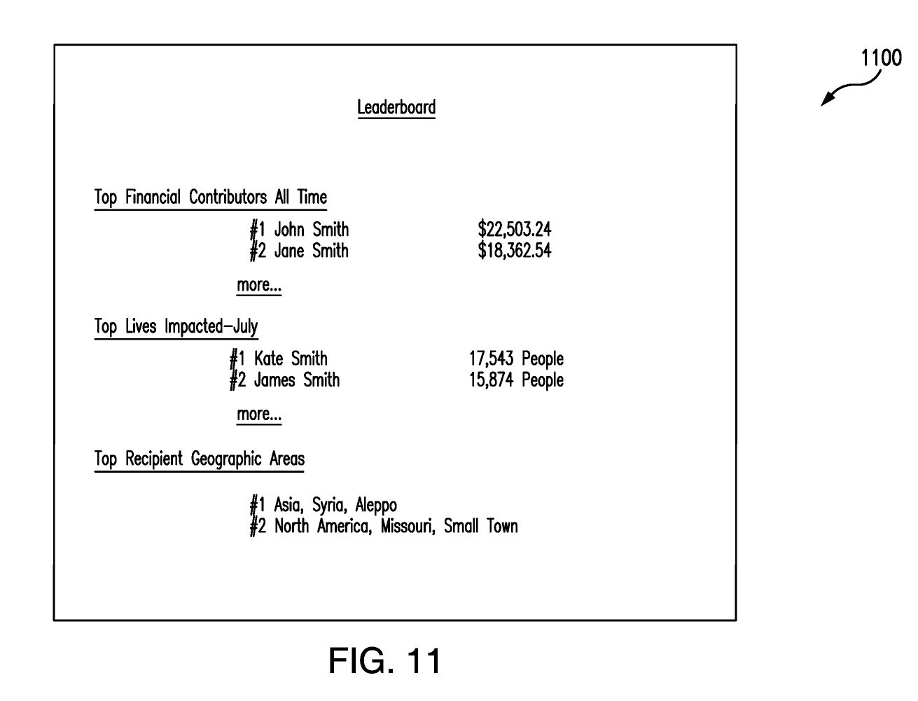

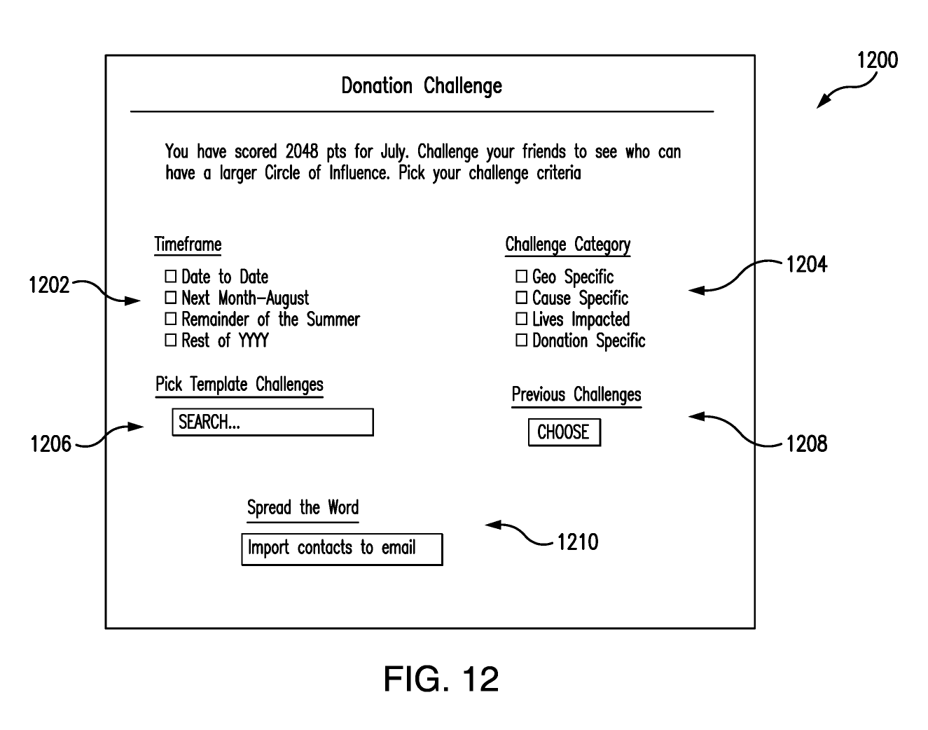

FIG. 11 illustrates an exemplary leaderboard interface 1100, which may be displayed to the donor 104a to show top donors in various different donation categories (e.g., upon selection of the leaderboard option 1010 from the interface 1000 of FIG. 10 by the donor 104a, etc.). In connection therewith, the interface 1100 includes various listings of top donors (either based on overall donors registered to the donation platform 122, or potentially based only on donors affiliated with donor 104a), for example, based on total financial contributions and based on total people impacted for the month of July, and a listing of geographic regions receiving the most donations. In various embodiments, the leaderboard may include a listing of donors based on points (e.g., where the points are a product of donation amount and people impacted, etc.), based on meals provided, based on vaccines provided, etc. And, FIG. 12 illustrates an exemplary challenge interface 1200, which may be displayed to the donor 104a to challenge other donors to make donations (e.g., upon selection of the challenge option 1008 from the interface 1000 of FIG. 10 by the donor 104a, etc.). In connection therewith, the interface 1200 includes various options for the donor 104a to compile a donation challenge for one or more contacts. For example, the interface 1200 includes options 1202, 1204 for the donor 104a to select a timeframe and a category for the challenge. Additionally, the interface 1200 includes options 1206, 1208 for the donor 104a to select predefined template challenges or to select from one or more prior challenges. The interface 1200 then further includes an option 1210 for the donor 104a to import contact information for friends and acquaintances, through which the challenges can be forwarded (e.g., emailed to select ones of the imported contacts, etc.).

It should again be appreciated that the interfaces 1000-1200 described above and illustrated in FIGS. 10-12 are exemplary in nature and do not limit the scope of the present disclosure, as various other interfaces, with similar or different content, may be used in other embodiments.

In various embodiments herein, it should be appreciated that the donation platform 122 may employ one or more different controls associated with the payment accounts of the donation recipients 110a-d registered to the donation platform 122.

For example, in one embodiment, the donation platform 122 may impose a limit threshold on donations to each, or some, of the donation recipients 110a-e. In particular in this example, the donation recipient 110b may be associated with a threshold limit that is equal to some percentage of a normal salary (e.g., 50%, 300%, etc.), that is associated with an interval (e.g., one week, one month, one quarter, one year, etc.), etc. In this manner, the donation recipient 110b may be limited in what he/she might be able to receive from a donor, which may, in some instances, protect the donation recipient 110b from theft and/or abuse, while also potentially preventing donors from giving beyond the donation recipient's needs and/or expected needs (e.g., potentially creating the perception of donation abuse, etc.), preventing money laundering, preventing fraudulent money activities, etc. Other controls may be imposed by the donation platform 122, which relate to the donors 104a-b or the donation recipients 110a-e, for one or more of the same of different purposes.

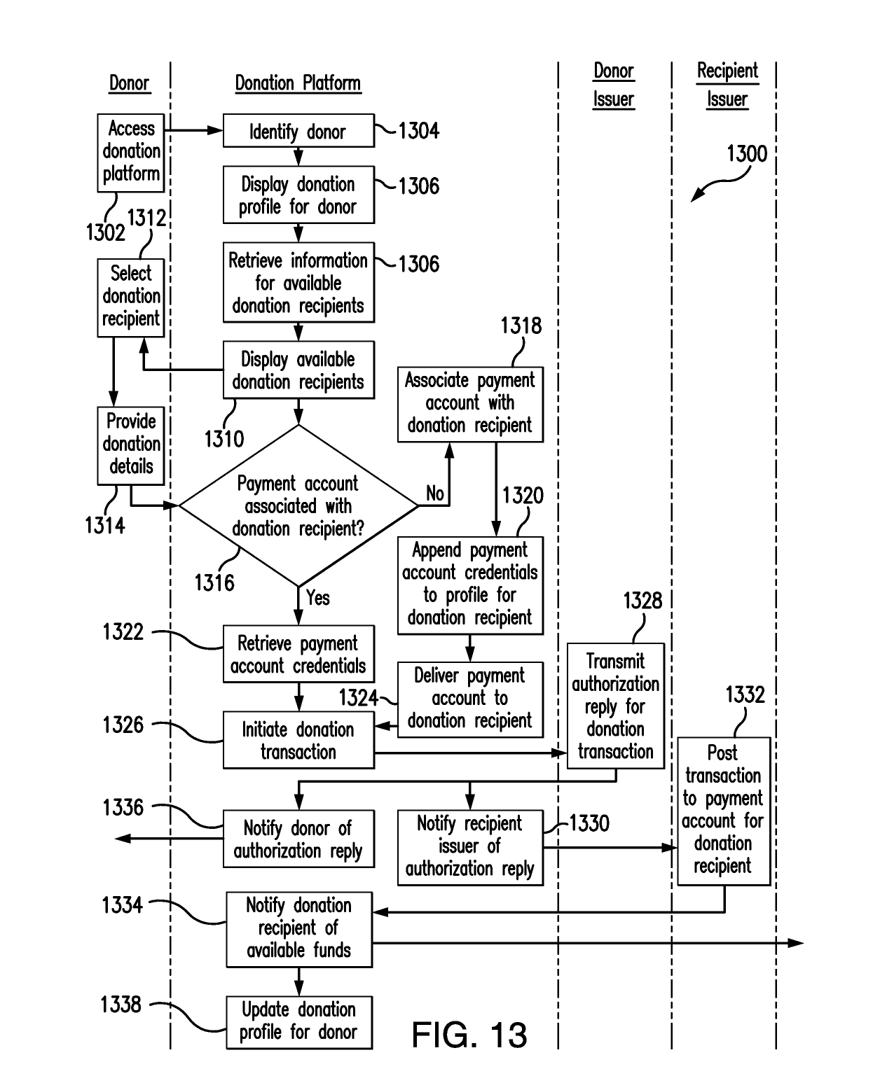

FIG. 13 illustrates an exemplary method 1300 for facilitating a donation transaction, for example, between a donor and a donation recipient. In connection therewith, the method 1300 is generally described with regard to a donation by the donor 104a to the donation recipient 110a, as implemented in the donation platform 122 and with reference to the computing device 200. It should be appreciated, however, that the methods herein are not limited to the system 100 and/or the computing device 200, and conversely that the systems and computing devices herein are not limited to method 1300.

In the method 1300, when the donor 104a (once registered to the donation platform 122) desires to make a donation, in general, the donor 104a accesses, by use of the communication device 114, the donation platform 122, at 1302, via the associated website (or, via a network-based application, etc.) provided by the donation platform 122. The donation platform 122 may require particular credentials (e.g., a username, a password, a PIN, etc.) for the donor 104a to obtain such access. In response, for example, to the credentials, or otherwise, the donation platform 122 identifies the donor 104a, at 1304. Thereafter, the donation platform 122 provides access to the profile associated with the donor 104a, and causes the website (or interfaces included therein such as interface 400 of FIG. 4, for example) to conform to the profile of the donor 104a, as appropriate, at 1306. In connection therewith, the donation platform 122 may display the network environment to the donor 104a, as particularly associated with preferences, donation history, etc. associated with the donor 104a (and/or his/her donation profile). As such, the network environment may include a listing of available donation recipients 110a-e to the donor 104a. Additionally, or alternatively, the network environment may include other donors linked to the donor 104a (e.g., based on invitation requests by the donor 104a, etc.), Circles of Influence associated with the donations made by the donor 104a (e.g., listings of the donation recipients 110a-e to which donations have been made by the donor 104a, listings of donations made by other donors in the Circles of Influence associated with the donor 104a, rankings (broadly, hierarchies) of donors in the Circle of Influence based on donation amounts or numbers of donations, etc.), etc. Regardless, the donor 104a may use information in the network environment to determine and/or evaluate aspects of a next desired donation.

At 1308, after identifying the donor 104a, the donation platform 122 retrieves information for the available donation recipients 110a-e, from the data structure 124 (as obtained during registration of the donation recipients 110a-e), to which the donor 104a may make donations. This may be done automatically by the donation platform 122, upon the donor 104a accessing his/her account (which may be considered, broadly, a donation request by the donor 104a). Or, this may be done in response to a particular selection by the donor 104a to make a donation (broadly, a selection of a donation request by the donor 104a). In either case, the donation platform 122 then causes an interface to display to the donor 104a, at 1310, at the communication device 114 (at the presentation unit 206), including entries for one or more of the available donation recipients 110a-e (as retrieved from the data structure 124). In connection therewith, each of the entries may include the profile(s) for one of the donation recipients 110a-e, or merely part thereof.

In response to the interface including the entries for the one or more of the available donation recipients 110a-e, the donor 104a selects, at 1312, one of the donation recipients 110a-e, such as the donation recipient 110a in this example, to which the donor 104a desires to make a donation. In turn, the donation platform 122 solicits donation details from the donor 104a for the desired donation to the donation recipient 110a. And, the donor 104a provides the donation details, at 1314. The donation details may include, for example, a confirmation that the donation is to be made to the selected donation recipient 110a, an amount of the desired donation, an indication of whether the donation is a one-time only donation or a recurring donation, an interval for the recurring donation (e.g., start date, end date, interval, etc.) if selected, and an indication of the payment account to be used to perform the donation (e.g., as selected from one or more available payment accounts at the donor's profile, etc.). As can be seen, the donation herein is driven by the donor 104a searching for the particular donation recipient 110a and desiring to make the donation to the donation recipient 110a.

Next in the method 1300, the donation platform 122 determines, based on the profile for the selected donation recipient 110a (as retrieved at 1308, or as subsequently retrieved here), whether a payment account is associated with the donation recipient 110a, at 1316. If a payment account is not yet associated with the donation recipient 110a, the donation platform 122 associates a payment account with the donation recipient 110a, at 1318, and appends payment account credentials for the payment account to the profile of the donation recipient 110a, at 1320 (e.g., in conjunction with the recipient issuer 108, etc.). The donation platform 122 then causes the payment account to be delivered, at 1324, to the donation recipient 110a, either embodied in a physical payment device (e.g., the payment card 126, one or more of the payment cards 128, etc.), or electronically (e.g., as a virtual card specific to a payment application of the donation recipient 110a (e.g., a virtual wallet card, etc.), etc.). Conversely, if the donation recipient 110a is already associated with a payment account, the donation platform 122 retrieves, at 1322, the credentials for the payment account as included in the profile for the donation recipient 110a.

Thereafter, in either case, the donation platform 122 initiates, at 1326, a donation transaction to the payment account associated with the donation recipient 110a (as generally described above in connection with the system 100). In particular, the donation platform 122 is configured to submit a corresponding authorization request to the donor issuer 102. The donor issuer 102 is configured to determine whether the donor's payment account is in good standing and whether there is sufficient credit or funds to complete the donation transaction. If approved, the donor issuer 102 is configured to provide an authorization reply, at 1328, back to the donation platform 122, which in turn transmits the reply, at 1330, to the recipient issuer 108, whereby the donation transaction is posted, by the recipient issuer 108, at 1332, to the payment account associated with the donation recipient 110a. Specifically, the funds associated with the donation transaction are deposited to the donation recipient's payment account. As described above, in numerous embodiments, the funds will be deposited to a physical prepaid card, which will be, or has previously been delivered to the donation recipient. In addition, or alternatively, the payment account may be associated with a virtual prepaid card, for example, stored in a payment application, at the communication device 116. In any case, the donation platform further provides, at 1334, a notification to the donation recipient 110a, so that he/she is informed of the available funds.

Alternatively, if the donor issuer 102 declines the transaction, the donor issuer 102 is configured to transmit an authorization reply, at 1328, indicating the decline back to the donation platform 122, thereby permitting the donation platform 122 to indicate the decline to the donor 104a, at 1336.

With continued reference to FIG. 13, in connection with effecting the donation transaction (when approved by the donor issuer 102), the donation platform 122 further alters, at 1338, one or more donation metrics for the donor 104a at his/her donation profile, to include the new donation transaction. In so doing, the network environment for the donor 104a (e.g., the donor's Circle of Influence, the donor's donation history, etc.) is updated to reflect the new donation. In addition, a donation history for the donor 104a may be updated, whereby the donation history may be maintained and accessible for the donor 104a for subsequent reference, for example, for tax reporting, etc. In connection therewith, the various donation recipients 110a-e may also include indicators (e.g., in their profiles, etc.) of whether or not donations by the donor 104a to the particular ones of the donation recipients are tax deductible (e.g., in a given country, etc.).

In view of the above, the systems and methods herein provide a unique donation experience for donors to make donations to donation recipients and, in so doing, also provide improvements to the field of commerce as it relates to network-based donation transactions. For example, unique donation environments are generated for donors, through which the donors are able to view profiles associated with donation recipients, select donations to make to particular recipients, initiate donation transactions for the donations, and challenge other donors to do the same. The donation environments are also particular to the donors and are customizable, so that each of the donors is provided with a unique donation experience (e.g., a unique listing of donation recipients, identification of a unique Circle of Influence, donation points and standings particular to the donors, etc.), and ability to immediately view the effects of their donations on particular donation recipients. The donation environments further allow the donors to view their donation efforts against other donors, for example through rankings, etc., thereby providing a gamification aspect to the donation environments that is not conventional and that may, in fact, potentially increase donation transactions.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) identifying a first entity associated with a profile in a data structure associated with the platform computing device; (b) causing at least one profile associated with at least one recipient to be displayed to the first entity at a computing device associated with the first entity; (c) in response to a selection by the first entity, at an interface provided by a platform computing device, of the at least one recipient: (i) retrieving credentials for an account associated with the at least one recipient; (ii) initiating a network-based transaction to the account associated with the at least one recipient; and (iii) altering a metric associated with the profile of the first entity consistent with the network-based transaction and modifying a hierarchy of the first entity relative to other entities based on the altered metric; (d) distributing funds associated with the network-based transaction to the account associated with the at least one recipient, when a total donation for an interval satisfies a limit threshold; (e) soliciting from the first entity an identification of a payment account for providing the funds to be loaded to the account associated with the at least one recipient; (f) transmitting a notification to the at least one recipient when the donation transaction is approved by an issuer associated with the payment account identified by the first entity; (g) generating a donation challenge, based on an input by the first entity, soliciting a donation to the at least one recipient; (h) identifying at least one contact associated with the first entity and transmitting the donation challenge to the at least one contact; (i) compiling a Circle of Influence for the first entity based on donations made by the first entity, the Circle of Influence including a listing of recipients to which donations have been made by the first entity; and (j) updating the Circle of Influence to include the network-based transaction and the at least one recipient associated therewith.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for facilitating a network-based transaction between entities, the method comprising:
identifying, by a platform computing device, a first entity associated with a profile in a data structure associated with the platform computing device;
causing at least one profile associated with at least one recipient to be displayed to the first entity at a computing device associated with the first entity;
in response to a selection by the first entity, at an interface provided by the platform computing device, of the at least one recipient:
retrieving, by the platform computing device, credentials for an account associated with the at least one recipient;
initiating, by the platform computing device, a network-based transaction to the account associated with the at least one recipient; and
altering, by the platform computing device, a metric associated with the profile of the first entity consistent with the network-based transaction and modifying a hierarchy of the first entity relative to other entities based on the altered metric.

2. The method of claim 1, wherein the at least one profile associated with the at least one recipient includes a profile interface, the profile interface including a testimonial from the at least one recipient.

3. The method of claim 1, further comprising distributing funds associated with the network-based transaction to the account associated with the at least one recipient, when a total donation for an interval satisfies a limit threshold.

4. The method of claim 3, wherein the interval includes one month.

5. The method of claim 1, wherein the network-based transaction includes a donation transaction; and
further comprising causing funds associated with the donation transaction to be loaded to the account associated with the at least one recipient.

6. The method of claim 5, further comprising sending a physical payment card associated with the account to the at least one recipient.

7. The method of claim 5, further comprising soliciting from the first entity, by the platform computing device, an identification of a payment account for providing the funds to be loaded to the account associated with the at least one recipient.

8. The method of claim 7, further comprising transmitting, by the platform computing device, a notification to the at least one recipient when the donation transaction is approved by an issuer associated with the payment account identified by the first entity.

9. The method of claim 1, wherein the metric includes a score for the first entity and wherein the hierarchy includes a ranking of the first entity relative to other entities based on the score; and
wherein altering the metric includes generating the score, consistent with the network-based transaction, based on a combination of a donation amount included in the network-based transaction and the at least one recipient.

10. The method of claim 1, further comprising:
generating, by the platform computing device, a donation challenge, based on an input by the first entity, soliciting a donation to the at least one recipient; and
identifying, by the platform computing device, at least one contact associated with the first entity and transmitting the donation challenge to the at least one contact.

11. The method of claim 1, further comprising:
compiling, by the platform computing device, a Circle of Influence for the first entity based on donations made by the first entity, the Circle of Influence including a listing of recipients to which donations have been made by the first entity; and
updating the Circle of Influence to include the network-based transaction and the at least one recipient associated therewith.

12. A system for facilitating a donation from a donor to a donation recipient, the system comprising:
a memory comprising profiles for multiple donors and profiles for multiple donation recipients; and
at least one processor in communication with the memory, the at least one processor configured to:
identify, in the memory, a profile for a donor from the profiles of the multiple donors;
generate a network environment particular to the donor based on the identified profile, the network environment including:
a listing of donation recipients, from the multiple donation recipients included in the memory, based on at least one donation preference of the donor;
a Circle of Influence for the donor including at least one of the multiple donation recipients included in the memory, wherein said at least one of the multiple donation recipients is associated with a prior donation from the donor; and
a ranking of the donor relative to the multiple other donors included in the memory based on a donation metric; and
in response to a selection by the donor of a donation recipient in the listing of donation recipients:
identify a payment account for the selected donation recipient; and
initiate a donation transaction to the identified payment account, whereby funds are transferred from a payment account associated with the donor to the identified payment account consistent with a donation by the donor to the donation recipient.

13. The system of claim 12, wherein the at least one processor is further configured to append the selected donation recipient to the Circle of Influence for the donor.

14. The system of claim 12, wherein the at least one processor is further configured to:
generate the ranking of the donor relative to the multiple other donors included in the memory based on the donation metric;
alter the donation metric consistent with the donation transaction; and
update the ranking of the donor relative to the multiple other donors included in the memory based on the altered metric.

15. The system of claim 12, wherein the at least one processor is configured, in connection with identifying the payment account for the selected donation recipient, to:
determine if the payment account is associated with the donation recipient; and
when the payment account is not associated with the donation recipient, retrieve payment account credentials for the payment account and associate the payment account credentials with a profile for the donation recipient in the memory.

16. The system of claim 12, wherein the at least one processor is further configured to:
generate a donation challenge, based on an input by the donor, soliciting a donation to the donation recipient; and
identify at least one contact associated with the donor and transmit the donation challenge to the at least one contact.

17. A non-transitory computer readable storage media including executable instructions for use in facilitating a donation from a donor to a donation recipient, which, when executed by at least one processor, cause the at least one processor to:
identify a donor associated with a profile in a data structure coupled to the at least one processor;
cause at least one profile associated with at least one donation recipient to be displayed to the donor at a computing device associated with the donor, the at least one donation recipient eligible to receive a donation from the donor; and
in response to a selection of the at least one donation recipient by the donor, at an interface provided by the at least one processor:
retrieve credentials for a payment account associated with the at least one donation recipient;
initiate a donation transaction from a payment account associated with the donor to the payment account associated with the at least one donation recipient; and
alter a donation metric associated with the profile of the donor consistent with the donation transaction and modify a ranking of the donor relative to other donors based on the altered donation metric.

18. The non-transitory computer readable storage media of claim 17, wherein the donation metric includes a score for the donor and wherein the ranking includes a ranking of the donor relative to other donors based on the score; and
wherein altering the donation metric includes generating the score, consistent with the donation transaction, based on a combination of a donation amount included in the donation transaction and a benefit provided to the at least one donation recipient.

19. The non-transitory computer readable storage media of claim 17, wherein the executable instructions, when executed by the at least one processor, further cause the at least one processor to:
generate a donation challenge, based on an input by the donor, soliciting a donation to the at least one donation recipient; and
identify at least one contact associated with the donor and transmit the donation challenge to the at least one contact.

20. The non-transitory computer readable storage media of claim 17, wherein the executable instructions, when executed by the at least one processor, further cause the at least one processor to transmit a notification to the at least one donation recipient when the donation transaction is approved by an issuer of the payment account associated with the donor.
